(19) United States
(12) Patent Application Publication
(10) Pub. No.: US 2011/0002474 A1
(43) Pub. Date: Jan. 6, 2011

(54) Active Noise Reduction System Control

(76) Inventor: Graeme Colin Fuller, Auckland (NZ)

Correspondence Address: Jackson Walker LLP, 112 E. Pecan, Suite 2400, San Antonio, TX, 78205, US

(21) Appl. No.: 12/696,197

(22) Filed: Jan. 29, 2010

Related U.S. Application Data
(60) Provisional application No. 61/206,251, filed on Jan. 29, 2009.

(51) Int. Cl. G10K 11/16

(52) U.S. Cl. 381/71.6

(57) ABSTRACT

An active noise reduction system for use with an ear piece uses an ultrasonic signal to determine the acoustic coupling between a speaker and a sensor microphone of the noise reduction system. The determination of the acoustic coupling may be used to adjust the game of the system to provide a closed loop game which optimises performance of the system.

### CROSS REFERENCE TO RELATED APPLICATIONS

This application claims priority to and the benefit of U.S. Provisional Application 61/206,251, filed Jan. 29, 2009, which is hereby incorporated by reference.

### BACKGROUND OF THE INVENTION

1. Field of the Invention

This invention relates to active noise reduction (ANR) systems which are also referred to as active noise cancellation (ANC) systems. More particularly, the invention relates to optimising the performance of feedback ANR systems that are used in audio handsets or headsets.

2. Description of the Related Art

ANR systems are well known. These systems reduce, or at best eliminate, unwanted noise by destructive interference. Therefore, the noise is cancelled by producing soundwaves that are effectively an inversion of the noise to thereby cancel the noise. ANR systems typically use feed-forward or feedback control to achieve this cancellation effect.

For example, an ANR headset that implements a feedback system typically has at least one earcup in which a speaker is provided for delivering sound to the ear of a user. A sensing microphone is usually provided in the space between the speaker and the user's ear. The sound sensed by the microphone is compared to a reference to provide an error signal representative of any unwanted noise adjacent to the human auditory canal. The error signal is fed to a controller that provides a signal to the driver to cancel the unwanted noise.

An ANR headset that implements a feed-forward system typically has an external sensing microphone located between the noise source and the ear. The microphone provides a signal corresponding to the noise to a controller which provides an output signal to the speaker that is designed to cancel the noise at the time it reaches the ear of the listener.

Both feedback and feed-forward control strategies have problems. Feed-forward operation suffers from deviations from assumptions relating to the coupling of noise into the human auditory canal. Feedback control inherently addresses this problem, but is susceptible to instability (i.e. oscillation) of the closed loop system in the presence of widely varying acoustic and physical conditions i.e. instability caused by changes in the characteristics of the open loop system.

In order to maintain stability in nearly all conditions for a feedback system, the controller gain is generally set at a level which provides stability for the closed loop system under worst case conditions. For example, if the system is provided in a headphone or a mobile telephone handset, then the controller gain must be set so that oscillation does not occur when the headphone ear cup is compressed against the head or the handset is pressed hard against the ear. Similarly, the gain must be set at such a level that oscillation does not occur due to temperature extremes.

The problem with this approach to design of a feedback ANR system is that the gain of the closed loop system must be set significantly lower than desired for the standard usage condition. The result is substandard performance, particularly in a highly variable environment such as in a mobile telephone handset.

Furthermore, the variation in open loop response, if uncompensated, gives rise to a variable audio frequency response.

As mentioned above, the classical arrangement of the speaker and sensing microphone in a feedback noise cancelling design is for the microphone to be closely coupled acoustically to the driver essentially within the device. This is the case in a standard ANR headphone where the microphone is in close proximity to the driver within the headphone earcup and also for ANR earphones where the microphone and driver typically occupy the same acoustic volume, this volume being coupled to the auditory canal via a pipe arrangement. This arrangement works successfully for applications where there is either little dynamic pressure differential, or a known pressure differential between the acoustic volume that the speaker and microphone occupy and the ear canal of the user. This is generally the case in a circumaural headphone or an earphone with a grommet seal which both have a good level of seal between the device and the ear or the ear canal.

There are, however, some applications where a good seal on to the ear or ear canal is not feasible or is not easily achieved. Such applications include (mono-aural) ANR in mobile telephone handsets and on-the-ear (e.g. supra-aural) headphones and earphones. In these applications, the acoustic signals in the volume within the device occupied by the driver are typically not representative of the acoustic signals external to the device.

### OBJECT

It is an object of the invention to provide an improved active noise reduction system, apparatus or method, or to at least provide an alternative to existing systems, apparatus or methods. In particular, it is an object of the invention to monitor the acoustic coupling condition between a sensing microphone and a speaker in an ANR system for purposes of dynamically optimising noise reduction performance for the given condition.

### SUMMARY

In one aspect the disclosed subject matter provides an active noise reduction system comprising:

an earpiece adapted to be held against a user's ear,
a speaker provided within the earpiece;
a sensing microphone for sensing noise adjacent to the earpiece;
a controller for receiving a signal from the sensing microphone and providing a signal to the speaker to cancel noise in a region adjacent to the earpiece and the ear of a user;
a signal generator to generate an ultrasonic signal for provision to the speaker, and
a filter to detect a sensed signal sensed by the sensing microphone resulting from the ultrasonic signal to determine the acoustic coupling between the speaker and the sensing microphone.

The system may be a feedback system in which instance the sensing microphone senses noise in the region adjacent to the earpiece and the ear of the user. In other embodiments the system may be a feed-forward system.

The acoustic coupling can be used to vary a parameter of the controller to optimise the active noise reduction performance of the system. In some embodiments the parameter is the gain of the controller.

In some embodiments the earpiece comprises a communications device handset, a first port acoustically connecting the speaker to the environment external to the handset, and a second port acoustically connecting the sensing microphone to the environment external to the handset.

Furthermore, the ultrasonic frequency may comprise a swept frequency or a plurality of ultrasonic frequencies.

In another aspect the disclosed subject matter provides a method of optimising performance of a feedback active noise reduction system having a speaker and a sensing microphone and a controller for receiving a signal from the sensing microphone and providing a signal to the speaker to cancel noise, the method comprising:

determining a relationship between open loop acoustic coupling between the speaker and the sensing microphone and optimal closed loop gain for the system;
monitoring the open loop acoustic coupling, and;
dynamically adjusting the gain of the controller to provide a system closed loop gain according to the determined relationship.

The open loop acoustic coupling may be monitored periodically or continuously in some embodiments.

In another aspect the disclosed subject matter provides an active noise reduction handset comprising:

a speaker within the handset;
a sensing microphone within the handset;
a first port acoustically connecting the speaker to the environment external to the handset, and;
a second port acoustically connecting the sensing microphone to the environment external to the handset.

In another aspect the disclosed subject matter provides a method of determining an indication of the acoustic coupling between two or more acoustically coupled transducers, the method including the steps of: providing a reference signal to a first transducer to generate a signal; using a second transducer which is acoustically coupled to the first transducer to detect a sensed signal resulting from the signal, and using the sensed signal to determine the required indication.

In some embodiments the first and second transducers comprise the acoustically coupled transducers.

In some embodiments the first and second transducers generate one or more of the following signal types: infrared; optical; electromagnetic.

In some embodiments the reference signal is a generated signal. In other embodiments the reference signal may be derived externally, for example utilising an existing signal such as a program audio or speech signal,

In some embodiments the indication is used to control an ANR system, for example controlling the gain and/or filter settings of a controller in the ANR system. This can therefore provide improvements in ANR performance and audio frequency response performance. Alternatively or additionally, the indication can be used for controlling power consumption in the ANR system.

In some embodiments the indication may comprise an indication of open loop gain, or open loop phase in an ANR system.

In some embodiments the acoustic signal is above the range of human audible perception.

When used to control an ANR system, the indication may be obtained periodically or continually while the ANR system is operational.

In a further aspect the disclosed subject matter broadly provides apparatus including an ANR system, the apparatus including an oscillator for generating a predetermined acoustic signal, a first transducer for receiving the predetermined signal and generating an acoustic signal, a second transducer which is acoustically coupled to the first transducer to detect a sensed signal resulting from the acoustic signal, and using the sensed signal to determine an indication of the acoustic coupling between the transducers.

In some embodiments the transducers comprise a sensing microphone and a speaker of the ANR system.

In some embodiments the indication is used to control the ANR system, for example controlling the gain of a controller in the ANR system or controlling power consumption in the ANR system.

In some embodiments the indication may comprise an indication of open loop gain, or open loop phase in the ANR system.

In some embodiments the acoustic signal is above the range of human audible perception.

When used to control the ANR system, the indication may be obtained periodically or continually while the ANR system is operational.

In some embodiments the apparatus comprises a handset, headset, headphone or earphone, or an earpiece of such apparatus.

In a further aspect the disclosed subject matter provides a method of controlling an ANR system, the method including the steps of using an acoustic signal outside the frequency range of human audible perception to sense a characteristic of the open loop system and adjusting a control parameter of the ANR system dependent on the sensed characteristic.

In a further aspect the disclosed subject matter provides ANR apparatus including sensing means to sense a characteristic of the open loop system from the acoustic signal, and control means to adjust a control parameter of the ANR system dependent on the sensed characteristic.

In some embodiments the apparatus includes signal generating means for generating an acoustic signal from which the open loop system characteristic can be sensed.

In some embodiments the generated acoustic signal is above the frequency range of human audible perception.

In another aspect the disclosed subject matter provides ANR apparatus including a housing, a speaker and a sensing microphone provided in the housing, the speaker and the sensing microphone each being separately ported externally of the housing such that acoustic coupling between the microphone and the speaker is forced to occur via the acoustic environment external to the housing.

In some embodiments the microphone and/or the speaker occupies its own acoustic volume within the housing.

Further aspects will become apparent for the following description.

### BRIEF DESCRIPTION OF THE DRAWINGS

One or more embodiments of the invention will be described below, by way of example, with reference to:

FIG. 1, which is a diagrammatic illustration of an ANR system;

FIGS. 2 to 4 which are plots of active noise reduction performance for a feedback system such as the system of FIG. 1 as a function of frequency, for different values of system gain; and

FIG. 5 which is a diagrammatic cross-section through part of a device including ANR, such as a headset, or on-the-ear headphone implementing an ANR system, for example the system of FIG. 1.

### DESCRIPTION OF EMBODIMENTS SHOWN IN DRAWINGS

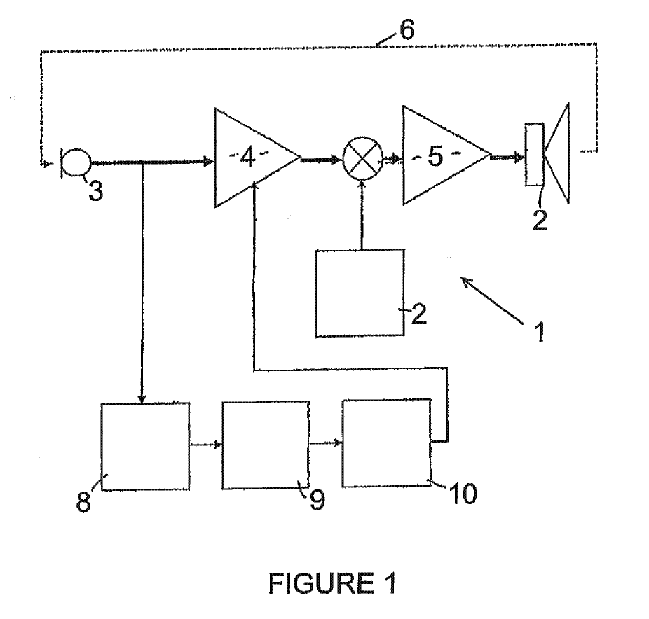

Referring to FIG. 1, an ANR system is shown, generally referenced 1. System 1, as illustrated, is a feedback system, but could alternatively be a feed-forward system, or even a hybrid system which incorporates elements of both feed-forward and feedback control. Those skilled in the art will appreciate that system 1 may be provided in a number of different products such as headphones, earphones, headsets or handsets.

As is known, system 1 includes a speaker 2 which transmits sound to a user. A sensing microphone 3 senses the audio signal from speaker 2 together with any noise that may be present. The sensed signal is provided to a controller 4 which provides an output signal adapted to reduce or eliminate the noise by cancellation. The controller output signal is amplified by a speaker driver 5 for delivery to the speaker 2 which transmits the sound the user wishes to hear (if any) together with the noise cancelling sound to destructively interfere with the noise sensed by the microphone 3.

The acoustic transfer path 6 between speaker 2 and sensing microphone 3 can vary depending on a number of parameters, for example the topology of a user's ear, or simply how closely a user holds a handset, for example the earpiece of a communications device handset such as a mobile telephone, to his or her ear. There may also be variations in the behaviour of the system components. As described above, in existing implementations the gain of controller 4 is set to maintain stability in the worst case.

In addition to the known arrangement described above, system 1 includes means to determine an indication of the acoustic coupling between the acoustically coupled speaker 2 and microphone 3, as will now be described. An oscillator 7 mixes a predetermined signal into the driver signal, and thus an acoustic signal is produced by speaker 2. In some embodiments the predetermined signal causes speaker 2 to produce an acoustic signal that is above the normal range of human audible perception. For example the acoustic signal is ultrasonic (i.e. above the usual human audible range). This means that the acoustic signal can be generated and processed without perception by a user of the ANR system. Furthermore, we have found that ultrasonic frequencies are more likely to be appropriately transmitted and detected by the speaker 2 and microphone 3, particularly in applications such as a telephone handset.

After the acoustic signal has traversed the acoustic transfer path it is sensed as a sensed signal by sensing microphone 3. At this point the sensed signal is filtered by a filter 8, such as a bandpass filter to extract the frequencies above 21 kHz (i.e. the ultrasonic component) and thereby sense the predetermined signal after it has traversed the acoustic path 6. The sensed signal is then appropriately conditioned if required, for example being passed to amplifier and rectification stage 9 to be amplified and rectified then averaged by averager 10 to provided an indication of the acoustically coupled response.

In the embodiment shown, the averager 10 provides a DC level signal which is representative of the gain of the open loop system between the speaker 2 and the sensing microphone 3. Thus the indication in the illustrated embodiment represents the gain of the open loop system.

The optimal relationship between controller gain and the acoustic coupling of the speaker 2 and sensing microphone 3 is determined for a given system. This can be achieved experimentally or by calculation for example. Once known, then as shown in FIG. 1 the output of the averager 10 can then be applied to the controller 4 to modulate the controller gain, thus realising an automatic gain control function. This allows the gain of the controller 4 (or another parameter such as frequency response) to be adjusted dependent to the changes on the acoustic transfer path (and/or changes in the response of the transducers due to temperature for example) to thus maintain optimal or near optimal noise reduction performance. Additionally, by compensating for the open loop response, variation in the audio frequency response can be minimised.

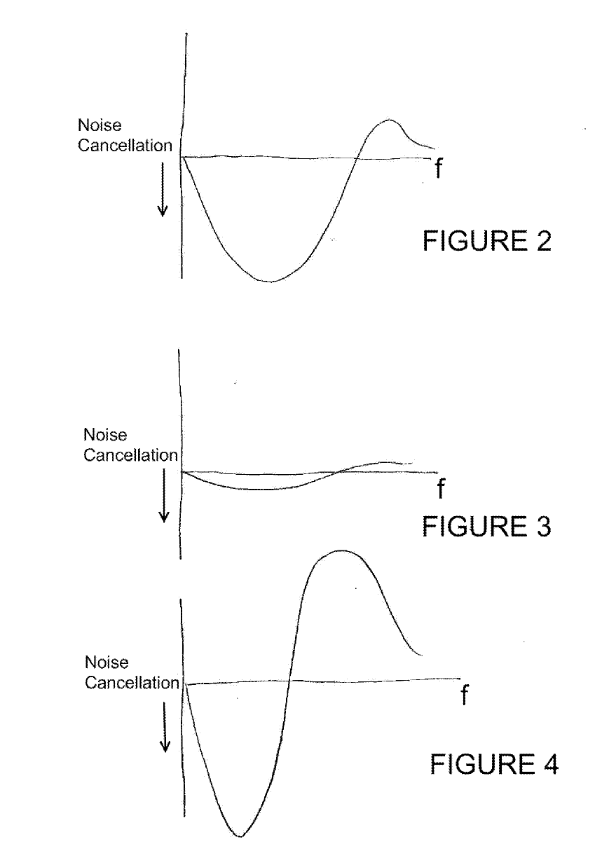

Referring now to FIGS. 2, 3 and 4 the effect of closed loop system gain on active noise reduction performance for a feedback system is shown as a function of frequency. FIG. 2 shows the optimal gain for a given acoustic coupling between speaker 2 and sensing microphone 3. This represents the best stable noise reduction performance over the frequency range of interest.

FIG. 3 shows performance when gain is too low for the acoustic coupling, and in FIG. 4 the gain is too great. In these cases not only does the active noise reduction performance suffer, but so too does the audio quality.

Those skilled in the art will realise that the system may be realised by analog or digital means, or a combination of both. Furthermore, the predetermined signal may be continuous or gated, as can be the operation of the detector. Moreover, the “frequency” of the predetermined signal may be a single frequency, or multiple frequencies, or swept frequency.

Other signals may be used to determine the acoustic coupling. In one example the speech or program audio signal may be used as a measure of the coupled response. This can be achieved by using an incoming speech or program audio signal (which gets mixed in to the signal pathway in order to be ultimately presented to the speaker) as a reference. This is then compared to the resultant signal received by the microphone from the speaker. The ratio of these two signals provides an indication of the acoustic coupling.

By using suitable filtering all or only part of the spectrum of the speech/program audio signal can be used.

In addition, or as an alternative, to regulating gain of the noise cancellation control loop, the disclosed subject matter may also be used to determine whether or not the product in which the system is implemented is in use. For example, in the embodiment illustrated, a significant increase on the open loop gain would indicate that the product is in use (i.e. the product has been brought into close proximity to the ear of a user). Conversely, a significant decrease in the open loop gain would indicate that the product is no longer in use. Detection of these changes can also be used to control power to the product or the noise cancellation system, for example by limiting or disconnecting power upon detection that the product is not is use.

As mentioned above, the disclosed subject matter may also be applied to other control methodologies. For example, in a feed-forward control system a speaker may generate an ultrasonic signal externally of the handset or headset in which the noise reduction system is provided. The signal may be sensed by a sensing microphone within the space or region in which active noise reduction is to occur (e.g. immediately adjacent to the auditory canal, or within the auditory canal) and in this manner an indication of the coupled response between the external environment and the noise controlled environment can be determined. This indication can be used to optimise the feed-forward control function, and other features. For example, the effective acoustic transfer function internal to external can be determined across the noise cancelling product assembly and the gain of the feed-forward controller can thus be adjusted accordingly in order to more accurately cancel the noise arriving internally.

Those skilled in the art will appreciate that the disclosed subject matter may be used to provide indications of parameters other than gain, for example an indication or measurement of the phase response can be provided.

Furthermore, in other embodiments other transducers may be used to provide an indication of the acoustic coupling between acoustic transducers 2 and 3. For example, an infrared, optical or electromagnetic signal (such as a radio frequency signal) may be used to provide an indication of coupling by detecting how close the transducers 2 and/or 3 are to a user's ear or head.

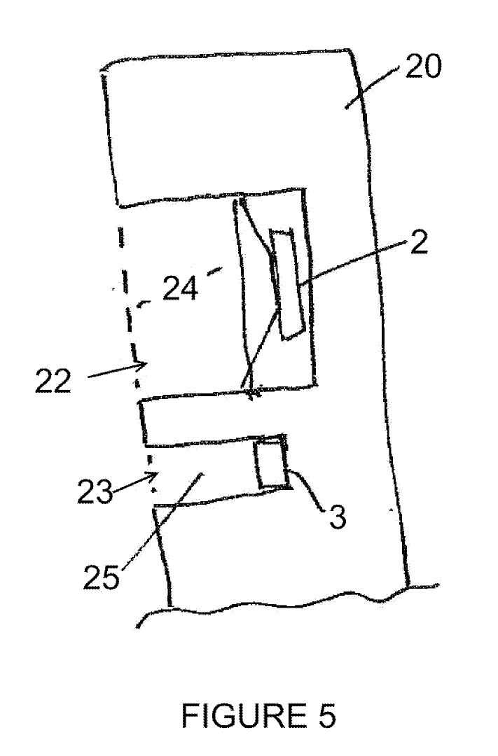

Turning now to FIG. 5, a means by which a feedback ANR device can operate successfully in the absence of good seal on to the ear or ear canal is illustrated diagrammatically. A housing 20 is partially shown in cross section, and may for example comprise an earpiece of a handset, headset or on-the-ear headphone. Speaker 2 delivers audio information to a user, and sensing microphone 3 is acoustically coupled to the speaker 2, sensing the audio delivered by speaker 2 and other noise that may be present to allow active noise cancellation to be implemented. The housing 20 includes a first port 22 for speaker 2 and a second port 23 for sensing microphone 3.

The embodiment of FIG. 5 acoustically decouples the driver and microphone within the device by having each of them occupy their own separate acoustic volumes, 24 and 25 respectively, within the device. These volumes are then connected to the external world via separate openings or ports 22 and 23.

In this manner the coupling between the transducers 2 and 3 is forced to occur via the acoustic environment external to the device. Therefore, by essentially forcing the microphone 3 to sample external to the device, the noise is controlled to a minimum at a point that is considerably closer to what the ear is sensing than if the microphone were sampling within the device.

Hence the result is improved noise cancelling performance, at the ear, relative to the classical embodiment.

Although certain examples and embodiments have been disclosed herein it will be understood that various modifications and additions that are within the scope and spirit of the invention will occur to those skilled in the art to which the invention relates. All such modifications and additions are intended to be included in the scope of the invention as if described specifically herein.

1. An active noise reduction system comprising:
an earpiece adapted to be held against a user's ear,
a speaker provided within the earpiece;
a sensing microphone for sensing noise adjacent to the earpiece;
a controller for receiving a signal from the sensing microphone and providing a signal to the speaker to cancel noise in a region adjacent to the earpiece and the ear of a user;
a signal generator to generate an ultrasonic signal for provision to the speaker, and
a filter to detect a sensed signal sensed by the sensing microphone resulting from the ultrasonic signal to determine the acoustic coupling between the speaker and the sensing microphone.

2. An active noise reduction system as claimed in claim 1 wherein the system is a feedback system and the sensing microphone senses noise in the region adjacent to the earpiece and the ear of the user.

3. An active noise reduction system as claimed in claim 1 wherein the system is a feed-forward system.

4. An active noise reduction system as claimed in claim 1 wherein the acoustic coupling is used to vary a parameter of the controller to optimise the active noise reduction performance of the system.

5. An active noise reduction system as claimed in claim 4 wherein the parameter is the gain of the controller.

6. An active noise reduction system as claimed in claim 2 wherein the earpiece comprises a communications device handset, a first port acoustically connecting the speaker to the environment external to the handset, and a second port acoustically connecting the sensing microphone to the environment external to the handset.

7. An active noise reduction system as claimed in claim 1 wherein the ultrasonic frequency comprises a swept frequency.

8. An active noise reduction system as claimed in claim 1 wherein the ultrasonic frequency comprises a plurality of ultrasonic frequencies.

9. A method of optimising performance of a feedback active noise reduction system having a speaker and a sensing microphone and a controller for receiving a signal from the sensing microphone and providing a signal to the speaker to cancel noise, the method comprising:
determining a relationship between open loop acoustic coupling between the speaker and the sensing microphone and optimal closed loop gain for the system;
monitoring the open loop acoustic coupling, and;
dynamically adjusting the gain of the controller to provide a system closed loop gain according to the determined relationship.

10. A method as claimed in claim 9 wherein the open loop acoustic coupling is monitored periodically.

11. A method as claimed in claim 9 wherein the open loop gain is monitored continuously.

12. An active noise reduction handset comprising:
a speaker within the handset;
a sensing microphone within the handset;
a first port acoustically connecting the speaker to the environment external to the handset, and;
a second port acoustically connecting the sensing microphone to the environment external to the handset.
